(19) United States
(12) Patent Application Publication
(10) Pub. No.: US 2012/0324561 A1
(43) Pub. Date: Dec. 20, 2012

(54) ROAD BLOCK the next evolution of security software for network operations

(76) Inventor: Michael A Kavanagh, Hilliard, OH (US)

(21) Appl. No.: 13/137,518

(22) Filed: Aug. 23, 2011

Related U.S. Application Data
(60) Provisional application No. 61/520,777, filed on Jun. 15, 2011.

(51) Int. Cl. G06F 21/20

(52) U.S. Cl. 726/11

(57) ABSTRACT

Road Block simply put is a blockade against any and all hacker attempts. It is a security software program that resides on a server and the user machine with specific coding interchanging between the two for a secure link and transference of information. Unlike VPN technology Road Block establishes a Binary code link specific to computer chips residing on a server and also on the user computer. This technology can be used by banks, medical offices, insurance companies, credit unions and facilities allowing employees to work remotely. In a nutshell Road Block is the ultimate security software package to ensure safe and secure transmission of any information between a user and server.

ROAD BLOCK simply put is a blockade against any and all hacker attempts. It is a security software program that resides on a server and user machine with specific coding interchanging between the two for a secure link and transference of information.

Unlike VPN technology, in which a rotating code is generated by a devise plugged into a port on a computer (where the signal can be hacked and outside presence can ride piggyback in on the signal) to allow access from remote locations. This technology relies on an open communication link established between the user and the server. Once the connection has been established any hacker that has the ability or has hacked the signal is now able to plant a virus or remove information from the server. The communication between the server and the user allows the hacker to hi-jack the signal and move within the server without detection.

ROAD BLOCK has some of the same properties as VPN technology as it does establish a remote connection between the server and user. This is where the technology between these two programs ends. Where VPN establishes a connection with a rotating code ROAD BLOCK will use only one binary code for access. YES, that is correct BINARY. All computer chips operate on a binary code and this is how they convey information between the chips that run a computer. A server also operates on the same principal. You cannot find these codes as they are in the root programming of the computer and are not accessible under normal circumstances. ROAD BLOCK will run on the ROOT programming and determine a set of code numbers between 4 and 26 digits in length and present this code to the server for access by the user.

The simplistic principal here is there are over 7 billion bits of information in a normal computer (binary code). Detailing a code between 4 and 26 characters long equates to 4 to the 7 billionth power, 5 to the 7 billionth power, ect up to 26 to the 7 billionth power. This program is to be installed on a user computer without the internet connected. Once connected to the internet it will transmit the code to the server allowing the user access to the specific programs in his profile of use. This communication between the user and the server should take 1/1000^{th} of a second.

Furthermore the signal is secure as in that 1/1000^{th} of a second the server program of ROAD BLOCK is designed to dissect the signal to determine if there are others attempting to hack the signal. The server will ping the other computers for their program of ROAD BLOCK and also look for the specific binary code assigned to their machine. If no code is found then they will be rejected and sent into a loop looking as if they are still trying to access the server on the signal. The server will identify their TCP/IP and will relay this to the security division in the corporation.

At this time they can back track the signal and determine through signal location who the user is and where they are located. The main point here is the hacker has been stopped and further attempts will also be prevented.

Experts have asked about emulation programs or similar road block protocols written to pass through the server. YES, there are emulation programs out there to pass for most anything using remote technology. The key is ROAD BLOCK is a program that will access the root program and has to pull coding from the chips in a specific computer. You can try to replicate this but once the server program tries to access your root program looking for the ROAD BLOCK specific protocol and code their connection will be lost. This is a program that is 4 fold.

1-There has to be a server program installed

2-The communication between a user and server is code specific

3-The program runs on the ROOT system of a computer

4-The program links ROOT code to ROOT Code

In item number 2 the words code to code are mentioned. Since there are almost infinite numbers of code, the server ROAD BLOCK program will define a code for each user but will not transmit that code across an open line of communication. This works somewhat like a lock on your home. You have a key to access your home and there are thousands of locks made by that company but there is only one key lock combination between the two. On most locks there are only 7 tumblers, on this program there can be an infinite number of codes on the server and the same on a user.

Because of this infinite number of codes in a server and also on an end user computer there is no chance emulation program can determine the Code to Code information needed to enter a server. This makes the program un-hackable.

This technology could be used by any entity that allows remote access via computer connection. Banks, Insurance Companies, Medical Offices, TPA's, Credit Unions, and other facilities allowing employees to work on remote access can use this program. Furthermore, a corporation can also install this on each computer located within their building.

ROAD BLOCK also offers tracking for each user to detail where they are moving on the server, what programs they are attempting to access, and if they are attempting to leave a virus on the server. Virus prevention on servers is still recommended to prevent a user planting anything that would harm the server. As this program is not hackable a user can open an account at a bank, purchase the ROAD BLOCK program and gain access to plant a virus. The problem with this scenario is, since the hacker opened an account has established a program code to code transmission, and is being tracked, it is fairly simple to find and prosecute this person.

ROAD BLOCK is specific to each corporation and just because you have a program linked with Chase bank does not mean you can use the same code for Bank of America. Each corporation will enlist a number of permits for user access (charge per person) and that programming will be specific for that corporation via 2 lines of programming in the server deployment.

In a nutshell ROAD BLOCK is a secure remote access program to ensure safe and secure transmission of any information between a user and server.

### INTRODUCTION

In this manual you will learn about networks, VPN security (Virtual Private Networking) and the need for security to protect computers. This manual has been written so the beginner can read, understand and use the technology enclosed in your packet. It is not meant to offend anyone's intelligence level nor is it meant to repeat information you may already know. It is simply meant to give instruction and information on how Network Protection works and the need for the ROAD BLOCK program.

We will discuss terms like Bandwidth, Signal, Hacker, Threat, VPN and Internal Network Security Protocol (INSP). These terms will be discussed lightly as most everyone will know or have some sort of understanding of the terms and use in a real world environment.

With this said let's get to the meat of the manual.

### CHAPTER 1

### Virtual Private Networking A.K.A VPN

VPN was developed by Checkpoint Software Technologies in 1994 and has been the primary software to protect networks for remote users and also networks prone to hacker attacks.

Some of these networks consist of banking, insurance and government software programs. Most Third Party Administrator companies dealing with insurance needs for corporations will let their workers use remote access to continue working from home to ensure projects are delivered on time. These companies manage products like flexible spending accounts and COBRA related issues. Since there are vast amounts of personal information on the core network there is a need for a protection system to keep the hacker from breaking into the system and downloading personal information. VPN security has been the security software for many years dealing with securing remote employees and also the network systems.

VPN works on a rotating code concept in which an initial code is assigned to allow access to the network servers. Once in the network the code will change on a schedule set by the administrator but the connection will continue with the user. This code is normally between 4 and 7 digits long with number and letter combination. Once the user enters the initial code they will be permitted to access the network and perform work as if they are located in the office plugged into a live wire connected directly to the network. There is one issue to contend with REMOTE ACCESS.

Remote access can allow hackers to piggy back on the signal, hack the VPN code and get into the system. Then they can back load the rotating code to emulate the VPN program or to install Malware and code on the user's computer to see exactly what they are using on the network. This malware will also allow a hacker to develop software to emulate the VPN technology the user is providing to get into the network and allowing the hacker to download any and all information on the network.

Once in the network the hacker can deploy a virus, or programs to send via email personal information of anyone connected to the server at any time. Running a piggy back or hacking a signal is the most popular way to enter a network on a VPN signal.

It has been proven that VPN technology although secure is not only hackable but also can be emulated by a high level hacker to obtain information from servers and networks.

Most network information managers and security personnel prefer to use VPN because it does offer a higher security and a difficult process for a hacker to break into network systems. The problem is IT CAN BE HACKED. By the time an information security manager has determined a hacker is present a great deal of information can be downloaded or a virus can be planted on the main server bank. Once the virus deploys it can down load most any information located on the server. It can also shut down programs which allow the company to function properly.

Most information security managers will not only operate the VPN network but also use back up protocol such as Norton Anti Virus or MacAfee products. The issue here is if a hacker is not deploying a virus he/she may not be picked up by the internal virus software programs. Thus leaving the hacker free to navigate and download information from the server.

With the development of higher down load speeds and larger bandwidth hackers can down load complete email lists, corporate information and financials in a matter of seconds.

If you are working on high speed signal, for example Time Warner Cable, down load speeds can be as high as 50 meg and up load can be 5 meg. This means you can down load a 500 meg document in about 3 seconds. Most VPN systems rotate the code every 25 seconds. Which means a hacker can piggy back on a user signal and get a great deal of information before he has lost communication with the server.

If a hacker sets a search parameter to pick up only name, address, social security, and phone information from a WA server, they could get personal information on roughly 500 people before they lose connection.

Since 1994 hackers have become smarter, VPN protection has become stronger yet the hacker population has become stronger. Why? Simple answer, Hackers are paid large amounts by companies, and individuals to retrieve personal information. This information is used to open credit accounts, establish false identities, invade bank accounts, and steal information associated with the people they have down loaded. Just consider of a server bank of physicians, 500 to be exact, and all the physician's personal information has been stolen during an offsite human resource open port. Not only are the physician's at risk but also the patients they service as well. Once the physician's information has been retrieved other server information is at risk as hackers can use the personal information to establish false identities to secure patient info.

### CHAPTER 2

### Internal Network Security Protocol INSP

INSP? This is the division that will secure virus protection, server security, and set up users to use programs on the server bank. For those that are unaware of this division in a corporation or business, you will most likely never see them, hear about them, or know how or where they operate. Most call this division BIG BROTHER. They track your computer usage, programs you are accessing, how long you are surfing the internet, communications between inside and outside sources and most importantly files you are sharing.

Hackers will develop an email with an attachment and send it to a number of users in a business. Once the attachment is opened a program is installed on the user computer and can allow access to remote use of the computer. GO-TO-MY-PC is a program that will allow you to access your desk top computer from any remote computer that has an Internet signal. If this program is on the open market for anyone to use think of what a hacker can install in just a few seconds on your computer once you open a document that has the program imbedded in the document code.

Once this program has been installed a hacker can see what a user is doing, obtain passwords for programs, look at files and has access to the server. A few companies have moved toward using a VPN network for all internal computers plugged into a hard line. Most INSP divisions feel more secure working on this network. The issue is once a hacker as a remote connection to your desk top, you do not have to have rotating code to access the server as you are all ready on the desk top that is hardwired to the server.

We are certain you feel at risk now but fear not it will get worse.

You hear on the news from time to time how a bank or financial institution has “been invaded and lost” account information of their customers. Invaded possibly but lost, not really. This is a hacker that has accessed the server and pulled a batch of information from the server containing credit card info, bank account information, social security numbers, and at times the ability to process a bank wire from account to account. If you have a bank account and a Visa/MC debit card attached to it you most likely have seen a letter stating “during processing of daily account information your account may have been misplaced by our servicing provider”. “Please advise the bank of any misuse or fraudulent account activity so we may rectify the issue as soon as possible”.

You expect banks to have secure server protection and not let this happen, yet every day hackers are pulling information from financial institutions across the nation. This does not mean you should start putting your money in a mattress. Banks for the most part are very secure. It does however prompt one to ask for more security.

### CHAPTER 3

### What is Road Block?

ROAD BLOCK is a security software package to establish a secure and safe connection between any computer and a server.

ANY COMPUTER? Any computer is defined as a user that has access to a server bank with permission from the INSP division. This does not include hackers.

ROAD BLOCK is a code to code communication security software package from user to server bank. VPN works on a similar technology with a rotating code. The major difference is ROAD BLOCK will access a code from the internal chips of a computer consisting between 7 and 26 digits long. Computer chips speak in binary code to each other and this is how they transfer information between programs. All letters, numbers and all pieces of information are transferred into a binary code to be processed by the internal chips of the computer.

Each chip may contain up to 7 billion pieces of binary code and in a computer you may find up to 26 chips using binary code to transfer information.

Because ROAD BLOCK will use between 4 and 26 digits that means you have 2.8 trillion different combinations for each set of 4 digits in a code. In a server there are many more chips conveying information which means there is an infinite number of codes that can be passed between a user and server bank.

Unlike VPN technology remote access to use the ROAD BLOCK program is not an option. VPN server connection does not determine how many computers are on a signal. However, ROAD BLOCK is able to determine if there is more than one computer on a signal or if it is remote access. Under remote access the computer will show two different signals, one from the desktop and another from the remote location. Determining the signal difference will prevent hijacking the signal and/or using remote programs like GO-TO-MY-PC.

After 9/11 security measures were put in place to keep a person from entering a boarding area with anything that may cause harm on a flight. ROAD BLOCK operates in the same fashion. When you log on your icon for access to your bank or insurance company or whatever you may be using the program for, you will access a server bank that is connected to the servers at the location you are trying to access. Somewhat like a security screening area at an airport. If you do not have the proper code or if you have hijacked a signal, using remote access, or outright hacking you will be stopped and your computer will be sent into a loop. It will appear you are going to gain access but in reality you are being tracked and this information is being sent to the security division of the facility you are trying to enter.

ROAD BLOCK also has a tracking program to follow your steps once in a server. Not only will your actions be tracked but all accessed programs, programs that were attempted to be accessed and most of all what a user attempted to leave on the server. If a user has permitted use of his computer to a hacker his account access and movements within the server will be tracked. It will show the user information, when they accessed the server, what they attempted to do, and when they exited the system. No longer will a user be able to state that they had no idea someone was on their computer. Any and all actions taken by a user, once in a server, will be tracked and recorded.

ROAD BLOCK will be licensed to verifiable companies only. The main use for this program will be banks, credit unions, and insurance companies. UNDER NO CIRCUMSTANCES WILL THIS PROGRAM BE USED FOR PRIVATE CHAT ABILITIES NOR WILL IT BE SOLD TO AN ENTITY THAT CAN NOT BE VERIFIED VIA PHONE, FAX, AND A PERSONAL VISIT FROM THE OWNERS OF ROAD BLOCK. An entity has to be in existence for over 5 years, registered with the state, all members of the board and authorized agents are able to be contacted and verified, and there is a personal verification of the facility by ROAD BLOCK OWNERS. If these terms are not met then the program cannot be purchased.

ROAD BLOCK is not designed for chat applications. There is neither functionality nor upgrades to install chat or messaging ability within the program.

The server function of ROAD BLOCK will serve in many different ways.
It will check signal strength of the user to determine if someone has found a way to piggy back on the signal.
It will track all movements of the user for the duration they are using the system
It will operate stand alone from the main server bank so any and all virus plant attempts will be stopped at the ROAD BLOCK server.
Because it is Code to Code access if another computer is detected the server program will ping the second computer (most likely a hacker) and if no code or user ROAD BLOCK program is found the loop program will be back-fed to the other unauthorized computer and the threat will be stopped.
Because it is Code to Code transmission, only a computer running the user program will be able to communicate with the server.

### Chapter 4

### Tracking Movements in the Client Server

There are many tracking programs on the market that will track movements in a computer system. This system offers real time tracking, real time security notification, and STAL programming. Real time tracking and security notification are simple and with the addition of the STAL Program it prevents the user from accessing restricted areas, planting a virus or hacking into protected areas. STAL stands for STOP TACTICS and LOCKDOWN. This portion of the ROAD BLOCK program is designed to help the running virus software on the server in preventing any attempt to plant malicious malware or spy ware.

The network security team can customize this portion of the program to look for possible threats, lock down a user profile and stop any tactics to plant improper software on the server. Not only does it lock down the user but also sends a real time notification to the security team so investigation can be made on what the user was trying to accomplish. If the security team does not see a threat then the lock down can be removed.

Tracking a user is a useful tool not only for security but also for a company to review actions of a user, development of pathways to help the end user to navigate faster and market products the users are gravitating toward. Marketing of a product based on a user's track record in a server can be a useful item to not only keep customers happy but also anticipate their needs and provide solutions before they become a desire. Provision of solutions for consumers needs before they ask is a positive way to increase retention and market to new clients.

### Chapter 5

### Overview and Comparison

In simple terms ROAD BLOCK is an unhackable software to protect server function and corporate information.

ROAD BLOCK offers:
Code to Code transmission for access to a server bank
A separate server bank to prevent hacker attempts from entering a client server
A tracking program to detail movements a user makes once in a server
No remote access for users via programs like GO-TO-MY-PC
Unsurpassed hacker protection
Unsurpassed server and information protection
All programs run on user machines as GHOST programs

This program also can be used in a corporate environment on each desk top computer. Since this program runs as a ghost program and the user has no idea it is running thus there is no possibility of the staff member disabling the program.

VPN offers:
A rotating set of code numbers assigned to a user for security precautions

ROAD BLOCK is unsurpassed in security protection and hacker detection. This is the only security program that operates on a separate server bank as a portal for users and offers ultimate security for corporate operations.

I claim:

1. A security Software package for computers, network operations and secure transmittal of information across intranet and internet connections.

2. Road Block being a non-hackable security software based on binary code communications between internal computer chips based in each operating computer.
